(19) United States
(12) Patent Application Publication
(10) Pub. No.: US 2013/0143099 A1
(43) Pub. Date: Jun. 6, 2013

(54) LITHIUM ION BATTERY

(71) Applicants: Jen-Chin Huang, New Taipei City (TW); Yu Zeng, Changshu City (CN)

(72) Inventors: Jen-Chin Huang, New Taipei City (TW); Yu Zeng, Changshu City (CN)

(73) Assignees: GOLDEN CROWN NEW ENERGY (HK) LIMITED, Kowloon (HK); SUZHOU GOLDEN CROWN NEW ENERGY CO., LTD., Changshu City (CN)

(21) Appl. No.: 13/362,784

(22) Filed: Jan. 31, 2012

(30) Foreign Application Priority Data
Dec. 2, 2011 (CN) 201110395185.7

(51) Int. Cl. H01M 10/02

(52) U.S. Cl. 429/153

(57) ABSTRACT

A lithium ion battery includes a cell assembly and a casing containing the cell assembly. The cell assembly includes a plurality of positive electrode plates and a plurality of negative electrode plates. The positive electrode plates and the negative electrode plates are alternatively arranged in a stack. Each positive electrode plate and each negative electrode plate includes a base substrate covered with electrode pastes. A total of 121-161 pieces of the positive electrode plates and the negative electrode plates are arranged within per 18 mm length of the battery.

### CROSS-REFERENCE TO RELATED APPLICATION

This application claims priority to and the benefit of, pursuant to 35 U.S.C. §119(a), Chinese patent application No. 201110395185.7, filed Dec. 2, 2011, entitled “LITHIUM ION BATTERY”, by Jen-Chin Huang and Yu Zeng, the content of which is incorporated herein by reference in its entirety.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference were individually incorporated by reference.

### FIELD OF THE INVENTION

The present invention generally relates to a rechargeable battery, and more particularly to a lithium ion battery.

### BACKGROUND OF THE INVENTION

Generally, rechargeable batteries can be charged or discharged numerous times in comparison with conventional primary batteries which cannot be charged. Nowadays, lithium (Li) batteries, lithium ion batteries, and Ni-MH batteries are widely used as rechargeable battery. The rechargeable battery is usually classified into a liquid electrolyte battery and a polymer electrolyte battery based on the electrolyte used in the battery. Typically, the lithium ion battery is a liquid electrolyte battery. In the art, the lithium ion battery is manufactured in various shapes, such as cylindrical, rectangular, and pouch shapes.

Usually, the shape of the lithium ion battery has a great effect upon the design and manufacturing of the cell structure. For example, the cylindrical battery generally has a winded cell core structure, while, for a rectangular shape battery, a plurality of stacked electrode plates constitute a cell core structure. Currently, there are several methods to manufacture the stacked electrode plates or cell core structure for rectangular battery. For example, Chinese Patent No. 101485033 discloses a Zigzag method. Chinese Patent No. 101174681 discloses an insulator-bagging method. Chinese Patent No. 101405911 discloses an insulator-sectioning method.

With the development of the material used therein, the lithium ion batteries are employed as power provider applied to the electric tools and the electric vehicle, and the battery performances of the lithium ion batteries can be improved for quick charging or discharging. However, conventional batteries with Zigzag method for the arrangement of the electrode plates, particularly the lithium ion batteries, cannot meet the requirements of quick charging or discharging.

Therefore, a heretofore unaddressed need exists in the art to address the aforementioned deficiencies and inadequacies.

### SUMMARY OF THE INVENTION

A lithium ion battery in accordance with the present invention comprises a cell assembly and a casing containing the cell assembly. The cell assembly comprises a plurality of positive electrode plates and a plurality of negative electrode plates. The positive electrode plates and the negative electrode plates are alternatively arranged in a stack. Each positive electrode plate and each negative electrode plate include a base substrate covered with electrode pastes. A total of 121-161 pieces of the positive electrode plates and the negative electrode plates are arranged within per 18 mm length of the battery.

One aspect of the present invention provides a lithium ion battery, which includes a cell assembly and a casing containing the cell assembly. The cell assembly includes a plurality of positive electrode plates and a plurality of negative electrode plates. The positive electrode plates and the negative electrode plates are alternatively arranged in a stack. Each positive electrode plate and each negative electrode plate include a base substrate covered with electrode pastes. A total of 121-161 pieces of the positive electrode plates and the negative electrode plates are arranged within per 18 mm length of the battery.

In one embodiment, at least one surface of the base substrate of each positive electrode plate is covered with the electrode pastes, and the positive electrode plates are formed by roller forming with a thickness thereof being about 90 μm -120 μm. In one embodiment, the electrode pastes include an electrochemical material and an adhesive, where the electrochemical material is nanoparticle lithium iron phosphate (LiFePO4) and the adhesive is polyvinylidene fluoride (PVDF). In one embodiment, the electrode pastes further include carbon nanotube (CNT) or nanometal.

In one embodiment, at least one surface of the base substrate of each negative electrode plate is covered with the electrode pastes, and the negative electrode plates are formed by roller forming with a thickness thereof being about 60 μm -80 μm. In one embodiment, the electrode pastes include an electrochemical material and an adhesive, where the electrochemical material is graphite or mesocarbon microbeads (MCMB), and the adhesive is polyvinylidene fluoride (PVDF). In one embodiment, the electrode pastes further include carbon nanotube (CNT) or nanometal.

In one embodiment, a thickness, a length and a width of the battery are multiples of 18 mm or 65 mm, respectively. In one embodiment, the thickness, the length and the width of the battery can be one of the following dimensions: 18 mm×36 mm×65 mm, 18 mm×65 mm×36 mm, 18 mm×65 mm×54 mm, 18 mm×65 mm×108 mm or 18 mm×65 mm×180 mm. In one embodiment, the length of each positive electrode plate and each negative electrode plate is about 6 mm-12 mm shorter than the length of the battery, and the width of each positive electrode plate and each negative electrode plate is about 3 mm-6 mm shorter than the width of the battery.

In one embodiment, the number of the negative electrode plates is more than that of the positive electrode plates by one, and each positive electrode plate is arranged at opposite sides thereof with one negative electrode plate.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a front view of a lithium ion battery in accordance with an embodiment of the present invention;

FIG. 2 is a perspective view of the lithium ion battery shown in FIG. 1; and

FIG. 3 is a perspective view of the positive electrode plates and the negative electrode plates of the lithium ion battery.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

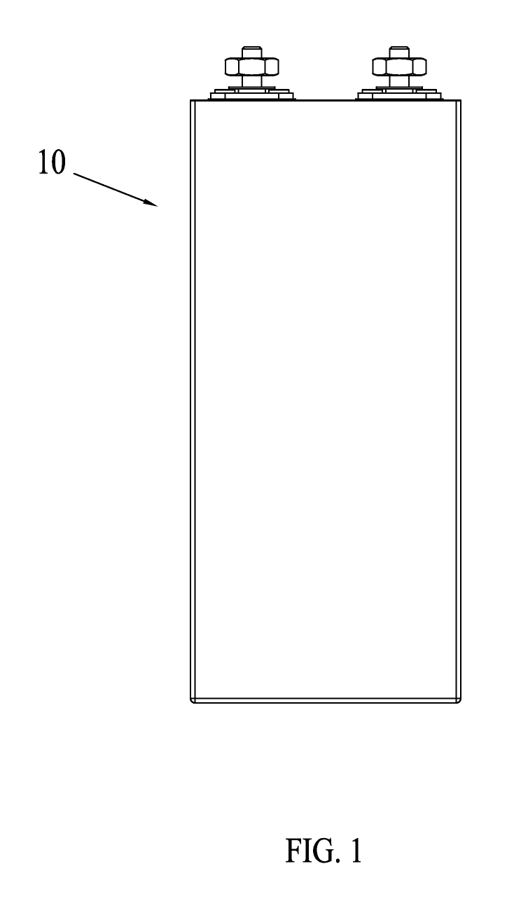

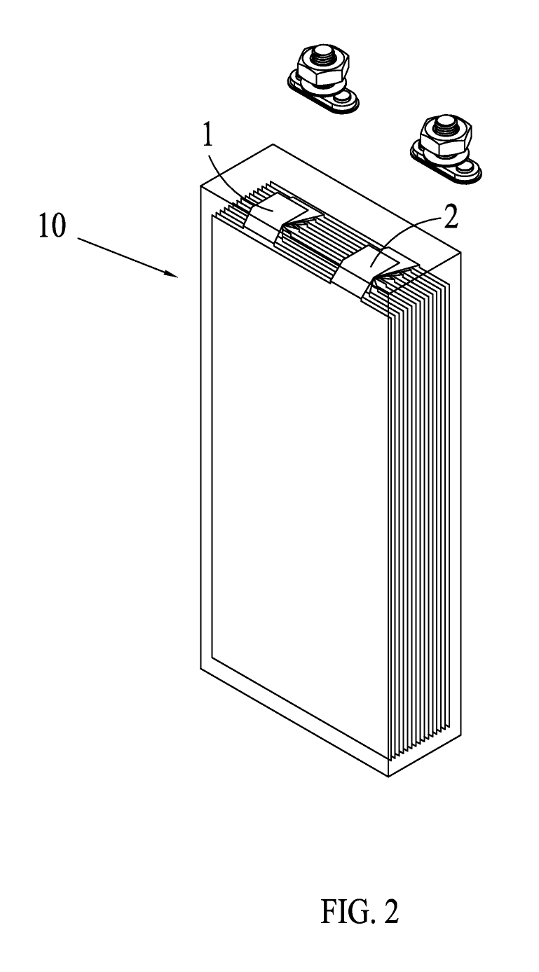

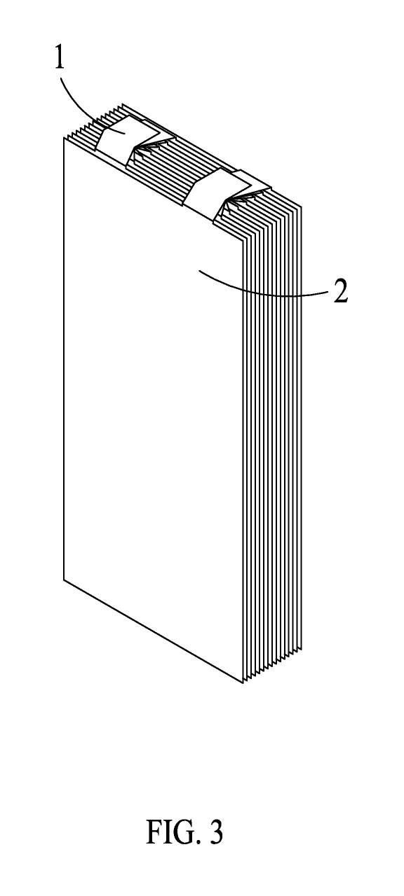

The description will be made as to the embodiments of the present invention in conjunction with the accompanying drawings in FIGS. 1-3. In accordance with the purposes of this invention, as embodied and broadly described herein, this invention, in one aspect, relates to a lithium ion battery.

Referring to FIGS. 1-3, a lithium ion battery 10 is shown as a rectangular lithium ion battery according to one embodiment of the present invention, which is usable for a power source of an external device. The lithium ion battery 10 includes a cell assembly. The cell assembly includes a plurality of positive electrode plates 1, a plurality of negative electrode plates 2 and a plurality of insulating separators (not shown). The positive electrode plates 1 and the negative electrode plates 2 are alternatively stacked with the insulating separators sandwiched therebetween.

Each positive electrode plate 1 includes a base substrate (not labeled). The base substrate of each positive electrode plate 1 can be formed with aluminum foil with a thickness of about 10 μm-20 μm. Electrode pastes are plated on both opposite surfaces of the base substrate. The thickness of the electrode pastes is about 20 μm-110 μm. The electrode pastes include an electrochemical material and an adhesive. The electrochemical material can be nanoparticle lithium iron phosphate (LiFePO4) and the adhesive is polyvinylidene fluoride (PVDF). The electrode pastes also include conductive agent, such as carbon nanotube (CNT) or nanometal. In pasting, the electrochemical material, the adhesive and the conductive agent are firstly mixed and combined to form the electrode pastes. Then, the combined electrode pastes are plated on the aluminum foil for roller forming. The total thickness of the base substrate and the plated electrode pastes is about 100 μm-200 μm. After roller forming, the thickness of each positive electrode plate 1 is about 90 μm-120 μm.

Each negative electrode plate 2 includes a base substrate (not shown). The base substrate of each negative electrode plate 2 can be formed with aluminum foil with a thickness of 8 μm-20 μm. Electrode pastes are plated on both opposite surfaces of the base substrate. The thickness of the electrode pastes is about 30 μm-60 μm. The electrode pastes include an electrochemical material, the adhesive and the conductive agent. The electrochemical material can be graphite or mesocarbon microbeads (MCMB). The adhesive can be polyvinylidene fluoride (PVDF). The conductive agent can be carbon nanotube (CNT) or nanometal. In pasting, the electrochemical material, the adhesive and the conductive agent are firstly mixed and combined to form the electrode pastes. Then, the combined electrode pastes are plated on the aluminum foil for roller forming. The total thickness of the negative electrode plate 2 is about 80 μm-120 μm. After roller forming, the thickness of the negative electrode plate 2 is about 60 μm-80 μm.

The shapes of both the positive electrode plates 1 and the negative electrode plates 2 are rectangular or square. In one embodiment, the electrode plate has a dimension of a 65 mm length and a width being multiples of 18 mm, such as 36 mm or 54 mm, etc. In some other embodiments, the length and the width of the electrode plates can also be multiples of 18 mm. The thickness, the length and the width of the battery 10 can be multiples of 18 mm or 65 mm, respectively. As can be understood, in actual practice, the electrode plates 1, 2 will be manufactured with a dimensional tolerance. In other words, if the length or the width of the battery 10 is a multiple of 18 mm, for example, 36 mm or 54 mm, the actual length or width of the electrode plates 1, 2 can be shorter than 36 mm or 54 mm. Consequently, the length of the electrode plates 1, 2 can be shorter than that of the battery 10 by 6 mm-12 mm, and the width of the electrode plates 1, 2 can be shorter than that of the battery 10 by 3 mm-6 mm.

In one embodiment, a battery 10 with a thickness of 18 mm is introduced. The battery 10 includes 60 positive electrode plates 1 and 61 negative electrode plates 2. Since the negative electrode plates 2 are arranged at both outermost sides of the stack of the electrode plates, the number of the negative electrode plates 2 would be more than the number of the positive electrode plates 1 by one. If the number of the positive electrode plates 1 is 80, the number of the negative electrode plates 2 is 81. In one embodiment, the thickness, the length and the width of the battery 10 can be one of the following dimensions: 18 mm×36 mm×65 mm, 18 mm×65 mm×36 mm, 18 mm×65 mm×54 mm, 18 mm×65 mm×108 mm or 18 mm×65 mm×180 mm.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. A lithium ion battery, comprising:
a cell assembly comprising a plurality of positive electrode plates and a plurality of negative electrode plates, the positive electrode plates and the negative electrode plates being arranged alternatively in a stack, each positive electrode plate and each negative electrode plate comprising a base substrate covered with electrode pastes; and
a casing containing the cell assembly;
wherein a total of 121-161 pieces of the positive electrode plates and the negative electrode plates are arranged within per 18 mm length of the battery.

2. The lithium ion battery as claimed in claim 1, wherein at least one surface of the base substrate of each positive electrode plate is covered with the electrode pastes, and the positive electrode plates are formed by roller forming with a thickness thereof being about 90 μm-120 μm.

3. The lithium ion battery as claimed in claim 2, wherein the electrode pastes include an electrochemical material and an adhesive, wherein the electrochemical material is nanoparticle lithium iron phosphate (LiFePO4) and the adhesive is polyvinylidene fluoride (PVDF).

4. The lithium ion battery as claimed in claim 3, wherein the electrode pastes further include carbon nanotube (CNT) or nanometal.

5. The lithium ion battery as claimed in claim 1, wherein at least one surface of the base substrate of each negative electrode plate is covered with the electrode pastes, and the negative electrode plates are formed by roller forming with a thickness thereof being about 60 μm-80 μm.

6. The lithium ion battery as claimed in claim 5, wherein the electrode pastes include an electrochemical material and an adhesive, wherein the electrochemical material is graphite or mesocarbon microbeads (MCMB), and the adhesive is polyvinylidene fluoride (PVDF).

7. The lithium ion battery as claimed in claim 6, wherein the electrode pastes further include carbon nanotube (CNT) or nanometal.

8. The lithium ion battery as claimed in claim 1, wherein a thickness, a length and a width of the battery are multiples of 18 mm or 65 mm, respectively.

9. The lithium ion battery as claimed in claim 8, wherein the thickness, the length and the width of the battery can be one of the following dimensions: 18 mm×36 mm×65 mm, 18 mm×65 mm×36 mm, 18 mm×65 mm×54 mm, 18 mm×65 mm×108 mm or 18 mm×65 mm×180 mm.

10. The lithium ion battery as claimed in claim 9, wherein the length of each positive electrode plate and each negative electrode plate is about 6 mm-12 mm shorter than the length of the battery, and the width of each positive electrode plate and each negative electrode plate is about 3 mm-6 mm shorter than the width of the battery.

11. The lithium ion battery as claimed in claim 1, wherein the number of the negative electrode plates is more than that of the positive electrode plates, and each positive electrode plate is arranged at opposite sides thereof with a pair of negative electrode plates.
